(19) United States
(12) Patent Application Publication
(10) Pub. No.: US 2004/0139023 A1
(43) Pub. Date: Jul. 15, 2004

(54) Method for implementing mpeg-21 ipmp

(76) Inventors: Zhongyang Huang, Singapore (SG); Ming Ji, Singapore (SG); Sheng Mei Shen, Singapore (SG); Takanori Senoh, Osaka (JP)

Correspondence Address: GREENBLUM & BERNSTEIN, P.L.C., 1950 ROLAND CLARKE PLACE, RESTON, VA, 20191, US

(21) Appl. No.: 10/474,028

(22) PCT Filed: Mar. 4, 2003
(86) PCT No.: PCT/JP03/02462

(51) Int. Cl. G06F 17/60

(52) U.S. Cl. 705/51

(57) ABSTRACT

A method of digital item processing in an apparatus for a MPEG-21 system has steps of: de-multiplexing the received digital item by a de-multiplexer 2.9, retrieving a digital item container 2.1 extracting Digital Item Declaration (DID) from the de-multiplexed digital item, parsing the DID by a DID parser 2.10 to interpret the actual meanings of each element of the DID, and transferring the element to Intellectual Property Management and Protection (IPMP) parser 2.19 for activating IPMP tools 2.17 if the element related to protection and management of the digital item.

### TECHNICAL FIELD

The present invention relates to method of digital item processing for use in an apparatus for a MPEG-21 system, specifically content distribution and protection in MPEG-21 (Moving Picture image coding Experts Group-21) scope. The present invention especially relates to such applications where the protected content is delivered and transferred based on MPEG-21 compliant devices and consumed based on standardised Rights Expression information.

### BACKGROUND ART

Today, many elements exist to build an infrastructure for the delivery and consumption of multimedia content. There is, however, no “big picture” to describe how these elements, either in existence or under development, relate to each other. The aim for MPEG-21 is to describe how these various elements fit together. Where gaps exist, MPEG-21 will recommend which new standards are required. MPEG will then develop new standards as appropriate while other relevant standards may be developed by other bodies. These specifications will be integrated into the multimedia framework through collaboration between MPEG and these bodies.

MPEG-21 aims at setting out a vision for enabling transparent and augmented use of multimedia resources across a wide range of networks and devices used by different communities. The setting up “big picture” is to describe how the specification of all the elements, which exist to build an infrastructure for the delivery and consumption of multimedia content. Now six key technical elements have been defined in MPEG-21: DID (Digital Item Declaration), DII&D (Digital Item Identification and Description), IPMP (Intellectual Property Management and Protection), RDD (Rights Data Dictionary), REL (Rights Expression Language), and DIA (Digital Item Adaptation).

Digital Items are defined as structured digital objects, including a standard representation and identification, and meta-data. This entity is the fundamental unit of distribution and transaction within the MPEG-21 framework as a whole. The means by which a Digital Item is defined is a Digital Item Declaration. The DID specifies the makeup, structure, and organization of a Digital Item. The DID has defined a useful model formed by a set of abstract terms and concepts for defining Digital Items. Within this model, a Digital Item is the digital representation of “a work”, and as such, it is the item that is acted upon (managed, described, exchanged, collected, etc.) within the model. The goal of this model is to be as flexible and general as possible, while providing for the “hooks” that enable higher-level functionality. This, in turn, will allow the model to serve as a key foundation in the building of higher-level models in other MPEG-21 elements.

In MPEG standardisation group, people are working towards to standardise an IPMP (Intellectual Property Management and Protection) system that involves compliant terminal. All the terminals can represent a protected content that is encrypted and protected by following the same IPMP standard, no matter what kinds of IPMP tools they use. The IPMP element should also fit into DID model. But the current MPEG-21 IPMP terminal architecture cannot fit the requirement for MPEG-21 framework based content-DI distribution and protection.

MPEG has identified the need for a Rights Expression Language (REL) and a Rights Dictionary Data (RDD) for long time. And now it is setting up two new parts for REL/RDD in MPEG-21 for standardization. Where is the place that the Rights holder including the rights expression information should be put is an issue for a practical system.

### DISCLOSURE OF INVENTION

An object of the present invention is to provide an interoperable and secure architecture to be used in MPEG-21 DI delivery or transmission in a secure manner.

Another object of the present invention is to provide the standard way for MPEG-21 IPMP system implementers to build a complaint MPEG-21 IPMP system for MPEG-21 related “content” distribution and protection.

Further object of the present invention is to design an appropriate and reasonable place to place the Rights Holder including Rights Expression information with the content under MPEG-21 IPMP system architecture and its mapping to MPEG-2/4 IPMP system.

The objects of the invention are achieved by following means:

a means to define and standardise a MPEG-21 system to be implemented in a compliant MPEG-21 Device;

a means to incorporate MPEG-21 IPMP into MPEG-21 system architecture;

a means to protect Resources using MPEG-21 IPMP system from request to consumption;

a means to define the place for Rights Holder to carry the rights expression information; and

a means to map the Rights Holder in MPEG-21 IPMP to MPEG-2/4 IPMP for content management and domain management.

On the content provider side, an incoming “content” is encoded and formed to be a MPEG-21 Digital Item. If the digital item is protected using MPEG-21 IPMP, IPMP Control Information needs to be retrieved and constructed. At the same time Rights Holder also needs to be retrieved and constructed.

Rights Holder should be carried in an appropriate place if it is bound together with the content, either sitting under IPMP system or parallel to IPMP system. It is also possible to be carried and transmitted out of the band.

After DID is received at MPEG-21 (DE)MUX and sent to DID parser, the DID parser extracts IPMP information and sends to IPMP parser. Then the IPMP parser extracts all IPMP information and transfers the information to IPMP Tool Manager and Message Router in MPEG-21 IPMP system. Other IPMP Information such as IPMP message, Keys, etc could be put as OpaqueData in IPMP Descriptor or the Resource element in DID. When there is Rights Expression information under IPMP Control Information Descriptor, it is transferred to REL parser. The parsed rights information can be enforced by Rights Management Tool carried in the DID or the Resource through Descriptor Reference (remotely). The Rights Expression information could also be carried out of band, or parallel to the IPMP information, or even scattered into different resources.

In other words, a first aspect of the present invention provides, a method of digital item processing for use in an apparatus for a MPEG-21 system, comprising: requesting a digital item to be delivered to the apparatus via a network, receiving the requested digital item, de-multiplexing the received digital item by a de-multiplexer, retrieving a digital item container including a Digital Item Declaration (DID) including one or more elements from the de-multiplexed digital item, parsing the DID by a DID parser to interpret the actual meanings of each element of the DID, and transferring the element to an Intellectual Property Management and Protection (IPMP) parser for activating an IPMP tool if the interpreted element is related to protection and management of the digital item.

A second aspect of the present invention provides, A method of digital item processing in an apparatus for a MPEG-21 system, comprising: receiving a DID menu together with other information including DID in a carousel style via a network, parsing DID by a DID parser to interpret the actual meaning of each element of the DID, making the DID menu to be readable by a user, selecting a digital item from the DID menu by the user, verifying rights and usage rules which is bound to the digital item if REL information is found with the digital item, retrieving the requested digital item, un-protecting the digital item for further consumption if the digital item is protected by IPMP, identifying a resource linked to the digital item, collecting the requested tools including IPMP tools, content representation tools, and DIA tools for consumption of the digital item, activating the tools according to predetermined message interface if such tools are required in the consumption of the digital item.

A third aspect of the present invention provides, A method of digital item processing in a MPEG-21 system, wherein the system includes a server and a client, comprising: browsing a DID menu stored in the server remotely from the client by a DID browser via a network, parsing and interpreting each DID element by the DID browser, selecting a digital item described by the DID by a user, verifying rights and usage rules bound to the digital item if REL information is found with the digital item, delivering the requested digital item from the server to the client, un-protecting the digital item for further consumption if the digital item is protected by IPMP, identifying a resource linked to the digital item, collecting the requested tools including IPMP tools, content representation tools, and DIA tools for consumption of the digital item, activating the tools according to predetermined message interface if such tools are required in the consumption of the digital item.

### BRIEF DESCRIPTION OF DRAWINGS

This and other objects and features of the present invention will become clear from the subsequent description of a preferred embodiment thereof made with reference to the accompanying drawings, in which like parts are designated by like reference numerals and in which:

FIG. 1 is an architecture diagram showing a basic conception of MPEG-21 IPMP architecture of the invention;

FIG. 2 is an architecture diagram showing MPEG-21 IPMP with Protected MPEG-21 DI (Rights Information under IPMP Control Information) according to a first embodiment of the present invention;

FIG. 3 is a diagram showing a relationship between DID, DIID and IPMP Scheme;

FIG. 4 is a diagram showing a data structure for rights carried out of the band;

FIG. 5 is a diagram showing a data structure for rights carried in MPEG-n system in global location;

FIG. 6 is a diagram showing a data structure for rights carried in MPEG-n system in local;

FIG. 7 is an architecture diagram for MPEG-21 IPMP with Protected MPEG-21 DI (Rights Information parallel to IPMP Control Information) according to a second embodiment of the present invention;

FIG. 8 is a diagram showing a data flow for rights carried in IOD of MPEG-4 system (rights information under IPMP control information);

FIG. 9 is a diagram showing a data flow for rights carried in IOD of MPEG-4 System (rights Information parallel to IPMP. Control Information);

FIG. 10 is a diagram showing an overview of an IPMP protected MPEG-2 content (rights information under IPMP control information);

FIG. 11 is a diagram showing an overview of an IPMP protected MPEG-2 content (rights information parallel to IPMP Control Information);

FIG. 12 is a flow chart of MPEG-21 DI consumption with rights Information carried inside IPMP Information;

FIG. 13 is a flow chart of MPEG-21 DI consumption with rights information carried before accessing IPMP Information;

FIG. 14 is an architecture diagram showing MPEG-21 IPMP with Protected MPEG-21 DI (Rights Information under IPMP Control Information) according to a third embodiment of the present invention;

FIG. 15 is a schematic architecture diagram for illustrating a DID menu transferred from a server to a terminal; and

FIG. 16 is a schematic architecture diagram for illustrating a DID menu stored in a server and browsed by a terminal.

### BEST MODE FOR CARRYING OUT THE INVENTION

Digital Items are defined as structured digital objects, including a standard representation and identification, and meta-data, which subordinates to the respective Digital Items to explain respective contents, for example, data on a title and copy authorization for motion picture. This entity is the fundamental unit of distribution and transaction within the MPEG-21 framework as a whole. Focusing on this unit related to MPEG-21, the six technical elements existing under MPEG-21 are briefly described and listed below:

Digital Item Declaration (a uniform and flexible abstraction and interoperable schema for declaring Digital Items): it specifies the mechanism for declaring the structure and makeup of Digital Items;

Digital Item Identification and Description (a framework for identification and description of any entity regardless of its nature, type or granularity): it specifies how Digital Items and parts and collections thereof can be described and uniquely identified;

Intellectual Property Management and Protection Architecture or Tool Representation and Communication System (the means to enable content to be persistently and reliably managed and protected across a wide range of networks and devices): it specifies information related to intellectual property management and protection associated with the Digital Item;

Rights Expression Language (a machine-readable language that can declare rights and permissions using the terms as defined in the Rights Data Dictionary): it specified flexible, interoperable mechanisms to support transparent and augmented use of digital resources and express their rights and interests in a way that addresses issues of privacy and use of personal data;

Rights Data Dictionary (a set of clear, consistent, structured and integrated definitions of terms for use in the MPEG-21 Rights Expression Language);

Digital Item Adaptation: provide tools to support resource adaptation, descriptor (“metadata”) adaptation, and Quality of Service management.

A “tool” referred to in this specification is a computer executable program to execute one or more predetermined processes such as mutual authentication, decryption which comforms to Data Encryption Standard (DES). Such programs are available in the form of Dynamic Link Libraries (DLLs), JAVA code program modules, etc.

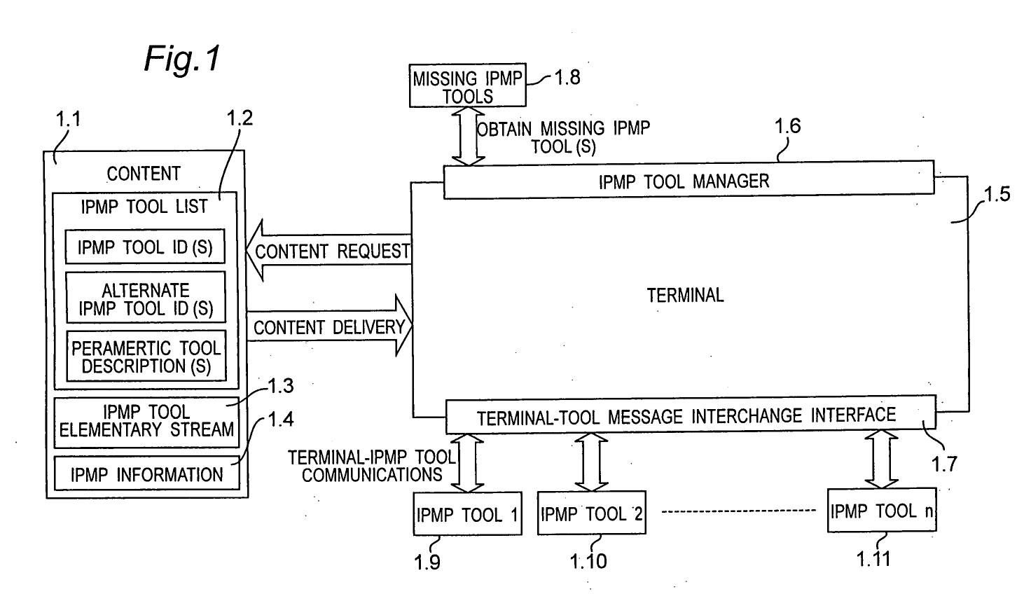

FIG. 1 shows basic concept to MPEG-21 IPMP system architecture. In FIG. 1, it is assumed that content in module 1.1 coming into MPEG-21 IPMP system is an MPEG-21 protected multimedia. In fact, under MPEG-21 “big picture”, the coming content is called Digital Item in MPEG-21 framework. Three units 1.2 1.3, and 1.4 in module 1.1 illustrate IPMP information transferred in content for IPMP system processing. An IPMP Tool List (unit 1.2) identifies, and enables selection of, the IPMP Tools required to process the Content. An IPMP Tool Elementary Stream (unit 1.3) identifies the actual tools carried in the Content itself. IPMP information (unit 1.4) identifies the information directed to a given IPMP Tool to enable, assist, or facilitate its operation.

As for right part of FIG. 1, it shows an MPEG-21 IPMP terminal 200 or client (module 1.5, a device that consumes possibly protected incoming content in compliance with the usage rules) including IPMP Tool Manager (module 1.6, proceeses IPMP Tool List(s) unit 1.2 and retrieve the IPMP Tools modules 1.8, 1.9, 1.10, 1.11 that are specified therein) and Message Router (module 1.7, implements the Terminal-side behavior of the Terminal-Tool interface). The module 1.8 of Missing IPMP Tools (not available in the module 1.5) and the module 1.9, 1.10, 1.11 of IPMP Tool (available in the module 1.5) denote the tool that perform (one or more) IPMP functions such as authentication, decryption, and watermarking.

### First Embodiment

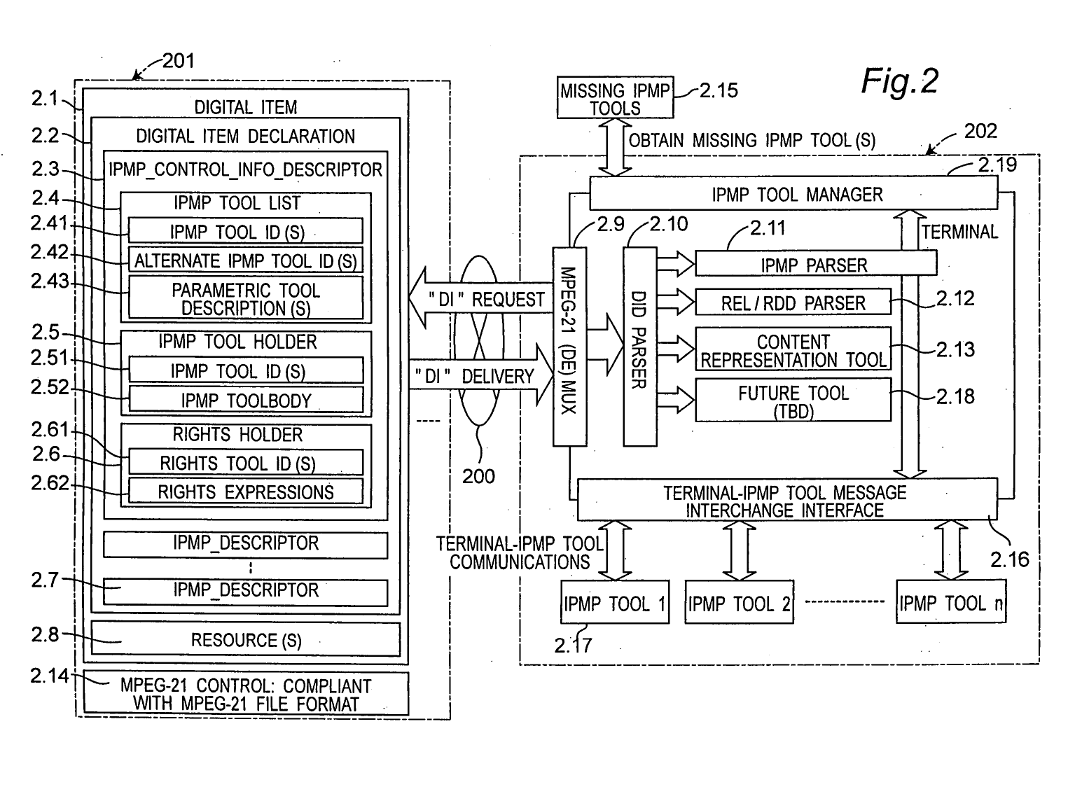

FIG. 2 shows a first embodiment of the present invention. As shown in FIG. 2, the updated Architecture Diagram for MPEG-21 IPMP is built on top of the assumed MPEG-21 System which may be MPEG-21 File Format (module 2.14). So in a MPEG-21 terminal 202 as shown in FIG. 2, a MPEG-21 System De-Mux module 2.9 is required to process binary-form MPEG-21 data which includes de-muxing and converting of DID binary to XML, then the processed data is passed to DID Parser module 2.9 for further processing.

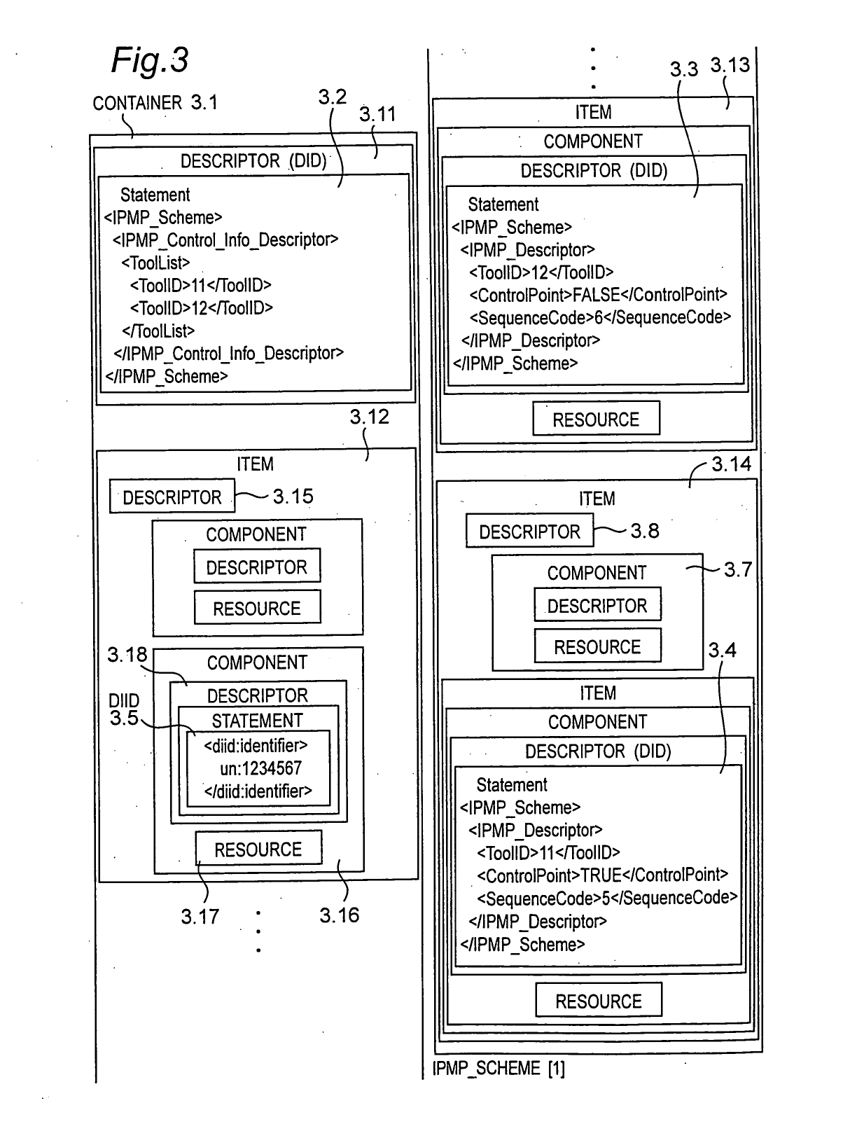

The means by which a Digital Item is defined is a Digital Item Declaration (unit 2.2). The whole structure is illustrated in FIG. 3. The DID specifies the makeup, structure, and organization of a Digital Item or digital item container (unit 2.1). The Digital Item includes a list of the resources, relevant metadata, and the relationships among the parts. The DID has defined a useful model (unit 3.1 in FIG. 3) formed by a set of abstract terms and concepts such as Container, Item, Component, Anchor, Descriptor, Condition, Choice, Selection, Annotation, Assertion, Resource, Fragment, Statement, etc (e.g. units 3.13, 3.7, and 3.8 shown in FIG. 3) for defining Digital Items. Within this model, a Digital Item is the digital representation of “a work”, and as such, it is the item that is acted upon (managed, described, exchanged, collected, etc.) within the model. The goal of this model is to be as flexible and general as possible, while providing for the “hooks” that enable higher-level functionality. This, in turn, will allow the model to serve as a key foundation in the building of higher-level models in other MPEG-21 elements. The IPMP element should also fit into this model.

The IPMP framework is a terminal system that supports tools for protecting Digital Item (DI) and enforcing rights expressions that might be associated with. One XML-based component, named “IPMP_Scheme” descriptor [1] under DID model to link DID with IPMP framework.

The new architecture diagram for MPEG-21 IPMP walkthrough concept considering MPEG-21 IPMP protected content-DI (unit 2.1) can be seen in FIG. 2. MPEG-21 protected contents in server 201 is illustrated in the left side, which can be considered as the basic MPEG-21 concept entity DI 2.1. The DI 2.1 includes crucial/core entity DID (unit 2.2) and its referred Resource (unit 2.8). We use “DI request” and “DI delivery” to denote MPEG-21 IPMP protected content-DI transmission through networks or communications 200. In FIG. 3, the whole DID model includes DIID (unit 3.5) and IPMP information (units 3.2, 3.3, and 3.4) held in IPMP Scheme descriptor can be seen. Two descriptors, “IPMP Control Information Descriptor (unit 3.2)” and “IPMP Descriptor (units 3.3 and 3.4)”. These Descriptors can also seen in the architecture diagram of FIG. 2 (units 2.3 and 2.7).

Again referring to FIG. 2, the Digital Item 2.1 includes DIDs 2.2 and Resources 2.8. Each of the DIDs includes the IPMP Control Information Descriptor 2.4 and the IPMP Descriptors 2.7. The IPMP Control Information Descriptor 2.3 includes a IPMP Tool List 2.3, a IPMP Tool Holder 2.5, and a Right Holder 2.6. The IPMP Tool List 2.4 includes IPMP Tool IDs 2.41, Alternate IPMP Tool IDs 2.42, and Parametric Tool Descriptions 2.43. Further, the IPMP Tool Holder 2.5 includes IPMP Tool IDs 2.51 and IPMP Tool Body 2.51. Furthermore, the Right Holder 2.6 includes Right Tool IDs 2.61 and Right Expressions 2.62.

With referring to FIG. 3, organization of digital item container 3.1 will be described in detail. The container 3.1 with the following arrangement is created by the server 201 by placing elements. From the beginning of container 3.1, Container 3.1 has Descriptor 3.11, Item 3.12, 3.13, and 3.14 in this order and is described in text format by using XML.

Descriptor 3.11 shows, for example, what types of Items are included in the container 3.1 and also called as Digital Item Declaration (DID), or as Container Descriptor. Descriptor 3.11 includes IPMP scheme descriptor 3.2, shown as “Statement”. At the beginning of IPMP scheme descriptor 3.2, the IPMP control information descriptor is placed, which describes a list of tool(s) to be used when the server 201 encodes a content.

Items 3.12 to 3.14 respectively relate to content such as motion pictures, still pictures, and audio. For example, Item 3.12 includes Descriptor 3.15 and one or more Components such as Component 3.16. Descriptor 3.15 describes unique information on Item 3.12. Component 3.16 includes resource 3.17 and Descriptor 3.18 for resource 3.17. The Descriptor (DID) 3.18 includes Digital Item Identification and Description (DIID) 3.5 which identifies Resource 3.17 by a identifier. The Resource 3.17 is an actual data such as motion pictures, still pictures, and audio. Alternately, Resource 3.17 may be URL (Uniform Resource Locator) which specifies a server in a network, in which the actual data is stored.

Each arrangement of Items 3.13 and 3.14 is the same as that of item 3.12. Items 3.13 and 3.14 have a Component which includes Descriptor (DID) and Resource. The respective Descriptors (DID) have Statements 3.3 and 3.4 as IPMP Scheme Descriptors. The IPMP Scheme Descriptor has an IPMP descriptor which specifies necessary IPMP information on one of completely described IPMP Tool information and related control message for specific protected resource. IPMP descriptor is placed in the nearest resource Descriptor (i.e. a Descriptor (DID) corresponding to the resource) within the same Component parent element under the DID, to be distributed to Users.

As shown in FIG. 2, different modules existing in the MPEG-21 system architecture can be briefly described as following:

1) MPEG-21 (De)Mux (Module 2.9)

It is the standard interface to the outside world of the MPEG-21 Terminal. It receives (and sends): DID of Digital Item(s) and Resources that form part of Digital Item(s). The (De)Mux 2.9 is required to process binary-form MPEG-21 data which includes demuxing and converting of DID binary into XML format (DIDL text).

2) DID Parser (Module 2.10)

The DID Parser receives the DID from the MPEG-21 (De)Mux 2.9 and parses the DIDL text declaring the structure of the Digital Item.

3) IPMP Parser (Module 2.11)

The IPMP Parser 2.11 receives the IPMP information text (in XML) bold in the DID, and parses it. It will usually use IPMP Tool(s) to act upon this IPMP information (and other information, e.g. REL).

4) REL Parser (Module 2.11)

The REL Parser receives the REL text (in XML) hold in the DID or IPMP information, and parse it.

5) Content Representation Tool (Module 2.13)

The Content Representation Tool 2.13 takes the content for e.g., decoding, composition, and rendering. It should be noted that the Content Representation Tools 2.13 are outside of the MPEG-21 Terminal for non-WG 11 standards.

6) IPMP Tool Manager (Module 2.19)

The IPMP Tool Manager 2.19 processes IPMP Tool List(s) and retrieve the IPMP Tools that are specified therein (e.g. obtain missing IPMP Tools 2.15 before Resource(s) 2.8 stars to consume). It is the key element to provide renewability if the IPMP Tool 2.17 is broken after a few years.

7) Terminal-Tool Messages Interchange Interface (Module 2.16)

It is implemented in the MPEG-21 Terminal, to use for communication/interfacing with proprietary IPMP Tools wich can be pre-implemented, or loaded from somewhere, and the IPMP Tools 2.17 can be renewed in future. Using such interface is to provide interoperability between different MPEG-21 IPMP terminals with different IPMP Tools.

8) IPMP Tools (Module 2.17)

It represents the proprietary Tool that performs IPMP functions and it can be provided by IPMP Vendors and built based on specified IPMP Interfaces.

The above three modules and the units 2.4 and 2.5 in FIG. 2 have the same functionality as modules 1.6, 1.7, 1.8, and 1.9, and units 1.2 and 1.3 in FIG. 1.

Next consumption of the DI protected by MPEG-21 IPMP will be described.

1) User Requests Specific Content.

After communication between the terminal 202 and the server 201 is established via the network 200, the following is made for the order in which different parts of the content are received and used:

a) IPMP Requirements on the Terminal 202 should be placed with or before media requirements on the Terminal 202; and

b) Access Information and/or restrictions should precede Content Stream download information. (IPMP_Control_Info_Descriptor)

After DID 2.2 is received at the MPEG-21 (DE)MUX 2.9 and sent to DID parser 2.10, the DID parser 2.10 extracts IPMP information and sends to the IPMP parser 2.11. Then the IPMP parser 2.11 extracts all IPMP information and transfers the information to the IPMP Tool Manager 2.19 and Message Router 2.16 in MPEG-21 IPMP system. Other IPMP Information such as IPMP message, Keys, etc could be put as OpaqueData in IPMP_Descriptor or the Resource element in DID. When there is Rights Expression information under IPMP_Control_Info_Descriptor 2.2, it is transferred to the REL parser 2.12. The parsed rights information can be enforced by Rights Management Tool carried in the DID 2.2 or the Resource through Descriptor Reference (remotely).

2) IPMP Tools Description Access

The Tool Manager 2.19 accesses the IPMP Tool List 2.4. Using the IPMP Tool List, the Terminal prepares and obtains the IPMP Tools required for protecting and consuming the content.

3) IPMP Tools Retrieval

If the IPMP tools 2.17 are available locally at the terminal 202, proceed to next step. Or, if IPMP tools are not available locally at the terminal 202, the terminal 202 attempts to obtain the Missing IPMP Tools 2.15. Some Missing IPMP Tools 2.15 may be carried in the Content itself. Otherwise, the Missing IPMP Tools 2.15 must be obtained remotely. In our proposal [2], it was mentioned that “IPMP Tool Stream” could be carried inside the DID (Tool Holder) or carried in the Resource through Descriptor Reference. The IPMP Tool Manager accesses/acquires the missing IPMP Tools. The “IPMP Tool Stream” can be carried inside the DID (Tool Holder 2.5) or carried in the Resource 2.8 through Descriptor Reference. The IPMP Tool Manager 2.19 accesses/acquires the Missing IPMP Tools 2.15.

4) Instantiation of IPMP Tools

The Terminal 202 instantiated the IPMP Tool(s) 2.17 locally or remotely. The instantiated IPMP Tools are provided with initial IPMP Information from the DID. One or more IPMP Tools, identified in the DID, may use IPMP Information to determine security requirements for content access, and monitor and facilitate the establishment and maintenance of these security requirements in inter-Tool communication.

5) IPMP Initialization and Update

This step is in parallel with Resource Consumption (DID parser 2.10 extracts references to Resources 2.8. MPEG-21 (DE)MUX 2.9 receives Resources 2.8 and sends to Resource Representation Tool). The Message Router 2.16 routes IPMP Information to the IPMP Tools 2.17 and the terminal 202 consumes the content if allowed by the requisite IPMP Tools 2.17. During Resource consumption, the complete procedure can be requested again. Requests for Resource consumption are implicit within the process.

Next, the enforcement of rights expression in MPEG-n IPMP system will be described.

The Rights Expression information can be put in different places considering different applications. Here Rights information includes all the Usage Rules, License key, etc., but not including time variant key information.

It is therefore possible to:

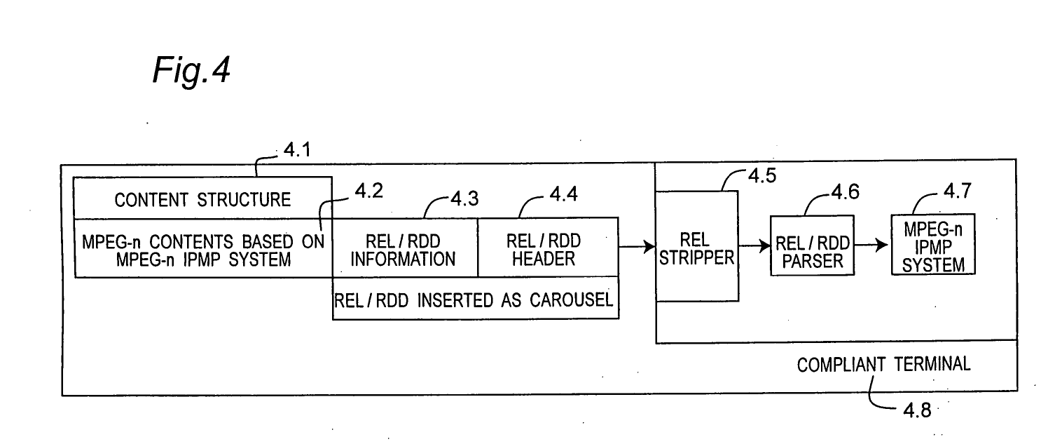

a) carry Rights information out of band (i.e. out of any specific systems like MPEG-2/4/21) but by defining a way to link the Rights Information with the relevant content in a normative manner for interoperability, as shown in FIG. 4;

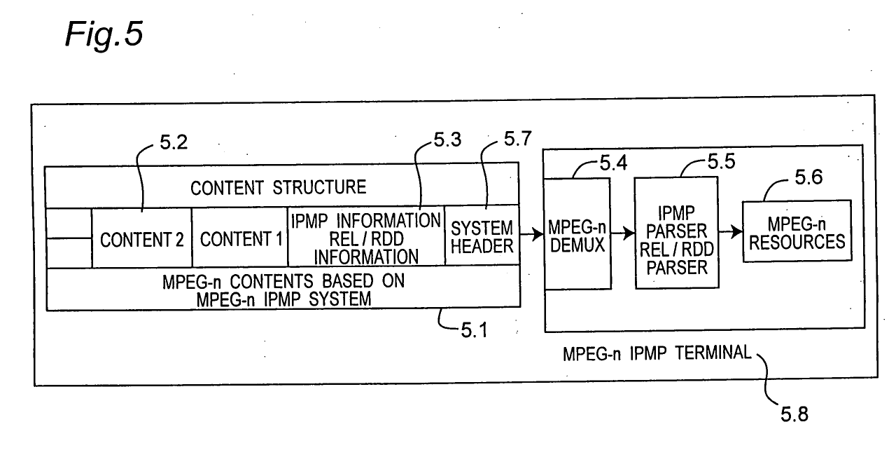

b) carry Right information inside the specific system but before any media content as a global Rights description, as shown in FIG. 5;

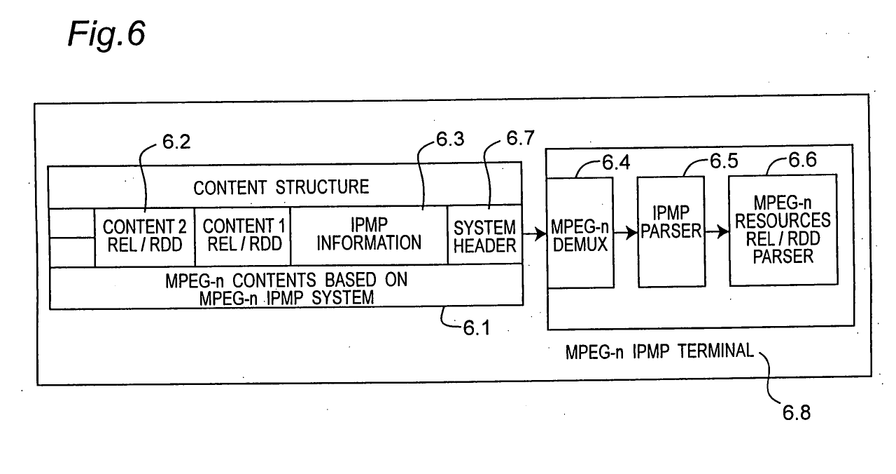

c) carry right Information in local to directly associated with its relevant content, in this way, rights information is actually scattered into each Resource, as shown in FIG. 6.

In the following, each item (a), (b), and (c) is further explained.

a) carry Rights Information Out of Band (I.e. Out of any Specific Systems like MPEG-2/4/21)

In FIG. 4, Rights Information carried out of the band is illustrated, where REL/RDD (unit 4.3) can be delivered off-line and also can be delivered on-line with the content (unit 4.2). In the later case REL/RDD 4.3 should have a header (unit 4.4) to indicate the segment of the REL/RDD part from the whole content that is transmitted to a compliant terminal 4.8. Then the units 4.2, 4.3, and 4.4 form the content structure (unit 4.1).

RDD is used for associating each right with its relevant content by pointing to the content identifier that will have different names in different system. For example, in MPEG-2 PID (Program Identifier) is used and in MPEG-4 OD id and ESD id is used to identify its content within that system.

REL/RDD information is created and attached together with the content that may be protected.

The REL/RDD (units 4.3 and 4.4) is inserted in the content as carousel to inform the terminal 4.8 about rights information at any time when user accesses the protected content.

The compliant terminal contains a REL Stripper (module 4.5) followed by REL/RDD Parser (module 4.6) that is linked to the MPEG-n IPMP System (module 4.7).

In this case REL/RDD does not belong to any part of MPEG-n system, even MPEG-21 system. It will spoil the integrity and interoperability of MPEG-n system.

b) Carry Right Information Insides the Specific System But Before any Media Content as a Global Rights Description

In FIG. 5 Rights information is carried in MPEG-n System in a global location, like IOD in MPEG-4 system, PSI in MPEG-2 system, and DID in MPEG-21 system. In this case REL/RDD belongs to one component of the MPEG-n system (module 5.1).

REL/RDD information (unit 5.3, as long as they are not the time variant key information) can be placed in a global location to describe all the relevant Rights information regarding all the consumed media contents before starting to consume any of the media contents (unit 5.2). It is done by associating each Right with the corresponding content identifier that is defined in RDD.

In the terminal 5.8, such a transmitted content is retrieved by MPEG-n Demux (module 5.4), then passed to IPMP & REL/RDD Parser (module 5.5) followed by MPEG-n Resources (module 5.6).

c) Carry Rights Information in Local to Directly Associated with Relevant Content, in this Way, Rights Information is Actually Scattered into each Resource

In FIG. 6 Rights information is carried in MPEG-n system (module 6.1) in local and scattered into each relevant content (module 6.2). In that case, Rights information has to be verified each time when user accesses the content where the Rights maybe digitally signed, which will cause repetitive workload to the terminal 6.8 compared to the method b) shown in FIG. 5. The terminal 6.8 includes a MPEG-n DeMUx (unit 6.4), a IPMP Parser (unit 6.5), and MPEG-n Resources and a REL/RDD Parser (unit 6.6).

It is clear that it is convenient to obtain all the Licenses and Usage Rules in the beginning just before consuming the content, like the way in a) and b).

After comparing three different ways to carry Rights in different places in the above, it is suggested to take method b) since it is good in the sense of integrity and consistence with MPEG-n IPMP system. In this case Rights Holder Position in MPEG-2/4/21 IPMP System is further discussed below.

Then, the Right Holder in MPEG-21 IPMP and its mapping to MPEG-2/4 IPMP will be described. Specifically, one detailed specification of the above-mentioned method “b” will be illustrated.

It is proposed to use Rights Holder (unit 2.6) in IPMP Control Information Descriptor (unit 2.3) to hold the Rights Expression information. IPMP Control Information Descriptor is designed with the outmost Container Descriptor's Statement. So the Rights information here is the outmost information before accessing the whole DID represented Items, Components, and Resources. This concept is illustrated in FIG. 2 as for the detail architecture of MPEG-21 IPMP system.

This diagram is an updated version by incorporating other elements of MPEG-21 into MPEG-21 IPMP. In the left side, an MPEG-21 Digital Item 2.1 protected by MPEG-21 IPMP is shown where Rights holder 2.6 is holding REL information and is placed under IPMP Control Information Descriptor 2.3. In an MPEG-21 IPMP terminal 202, REL parser (module 2.12) is required to interpret and transfer Rights permission to the terminal 202 before starting to consume any content.

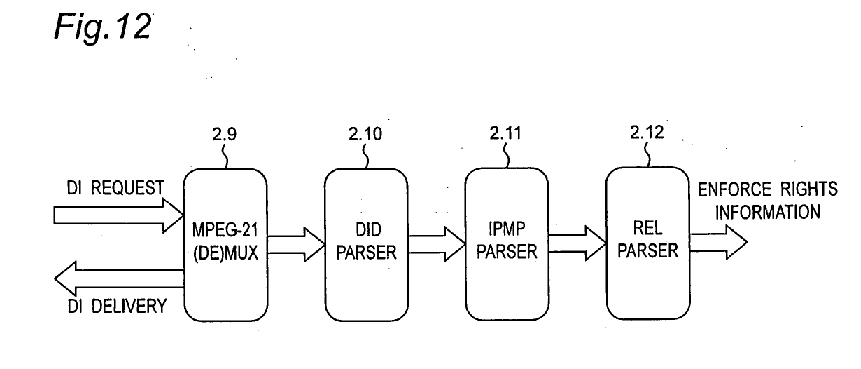

The FIG. 12 shows the flow chart of MPEG-21 DI consumption with Rights information carried in IPMP Control Information. In FIG. 12, same numeral as that in FIG. 2 is allocated to each element.

There are several advantages to hold the Rights Expression information in such a way:

a) The entire Rights Expression part can be easily protected by IPMP system, and in the terminal the Rights information is just needed to be verified once before any content to be consumed.

b) When the DI is entirely protected by the IPMP system so that a customer would have the opportunity to review the license agreement before actually executing any of the protected resources.

c) It will be convenient for content creator. This is exactly true when the Resource(s) is ready-made and content creator won't change the Resource any more.

d) It is easy to map to the existing MPEG-2/4 IPMP if this structure is adopted in MPEG-21 IPMP.

Then, mapping Rights Holder position from MPEG-21 to MPEG-4 IPMP will be described.

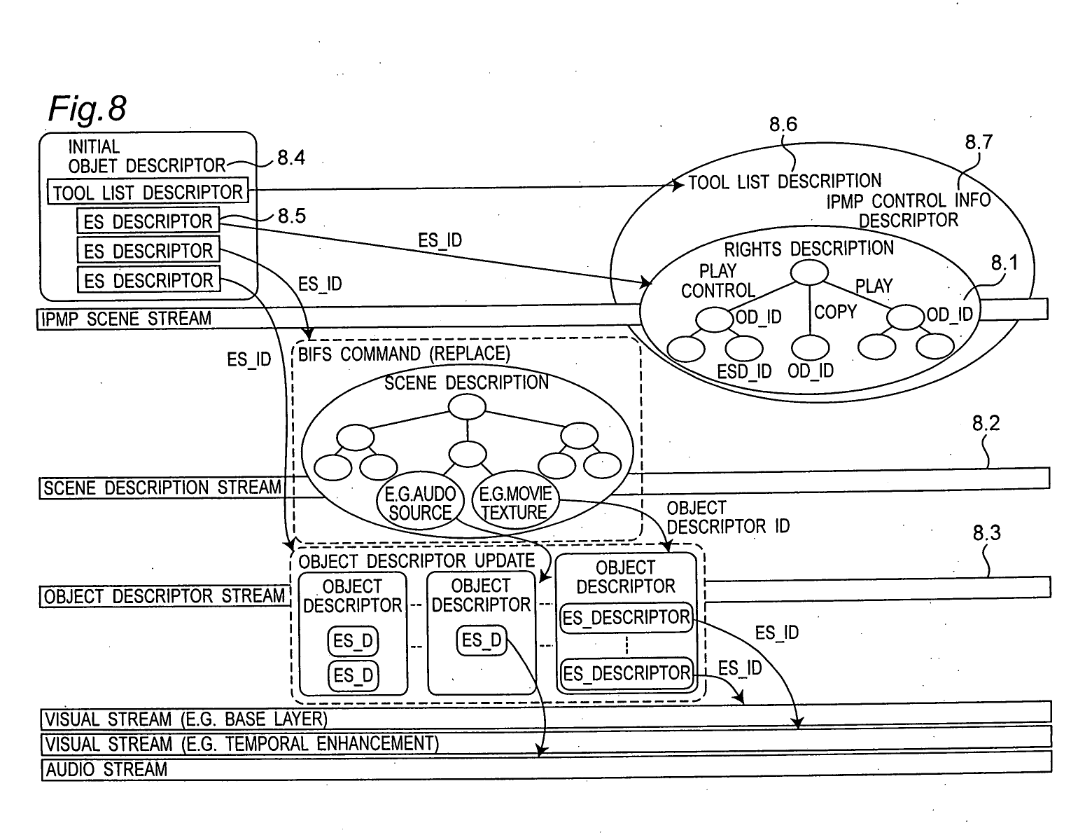

As shown in a Diagram of FIG. 8, the reasonable place to carry such XML based Rights messages unit 8.1 (in binary format) is in one of the Elementary Streams like Scene Description Stream (unit 8.2) or Object Description Stream (unit 8.3). Inside the IOD (unit 8.4), an ES Descriptor (unit 8.5) will describe the stream. This ESD with IPMP Tool List Descriptor (unit 8.6) forms MPEG-4 IPMP Control Information Descriptor.

In such case, BIF Stream describes the relationship between different objects in term of spatial relationship and time relationship, while IPMP Scene/IPMP Rights stream describe different rights permissions applied to each object by using OD ID and ESD ID to associate with the corresponding contents.

If it is preferable that a tidy and clear Rights Structure for all the Objects set up in the beginning of decoding, this way is the best choice. At the same time, an Overall IPMP Scene Structure can also be provided to be used in the Content Creation to illustrate the relationship for different kinds of Rights applied to different objects.

This way also makes good sense since IOD is the entrance point in MPEG-4 IPMP just like DID is the entrance point in MPEG-21 IPMP. It is indeed an appropriate mapping from MPEG-21 IPMP to MPEG-4 IPMP.

If Rights information is transmitted with the content where the content and Rights information are tightly bounded together, we have to define a normative way for carrying the rights in pre-defined location for interoperability. We also consider a new stream for MPEG-4 IPMP system to carry Rights information in a pre-defined location. The same suggestion is further elaborated in this invention.

Next, Mapping Rights Holder position from MPEG-21 IPMP to MPEG-2 IPMP will be described.

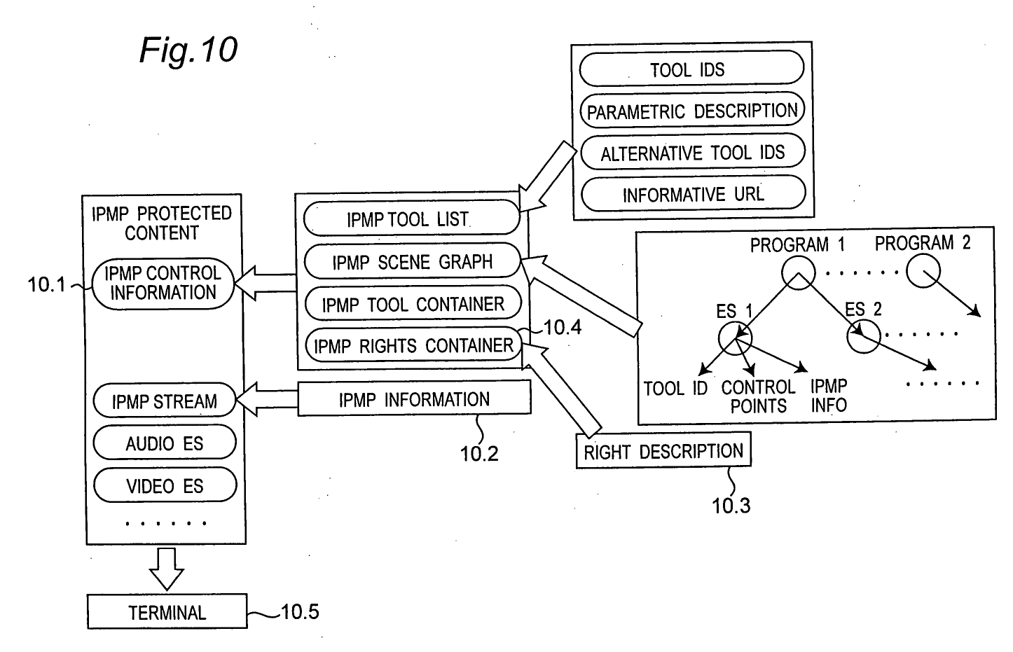

In MPEG-2 system, as indicated in current working draft of MPEG-2 IPMP, IPMP Control Information (refer to unit 10.1 in FIG. 10) defined as another table besides PAT, PMT tables, is inserted to PSI (Program Specific Information) to describe IPMP related information as well as Rights Description or Rights information (unit 10.3).

Before content is started, all IPMP and Rights information will be retrieved and processed according to their associated PID (Program Identifier) numbers.

As shown in FIG. 10, a Content Structure protected by MPEG-2 IPMP system is illustrated where Rights information is carried in IPMP Rights Container.

It is another good mapping from MPEG-21 IPMP to MPEG-2 IPMP since PSI is the entrance point in MPEG-2 IPMP just like DID is the entrance point in MPEG-21 IPMP.

IPMP and Rights information placed in PSI in MPEG-2 IPMP is similar to IPMP and Rights information placed in DID in MPEG-21 IPMP.

### Second Embodiment

A second embodiment relates to another detailed specification of method “b” described in the first embodiment.

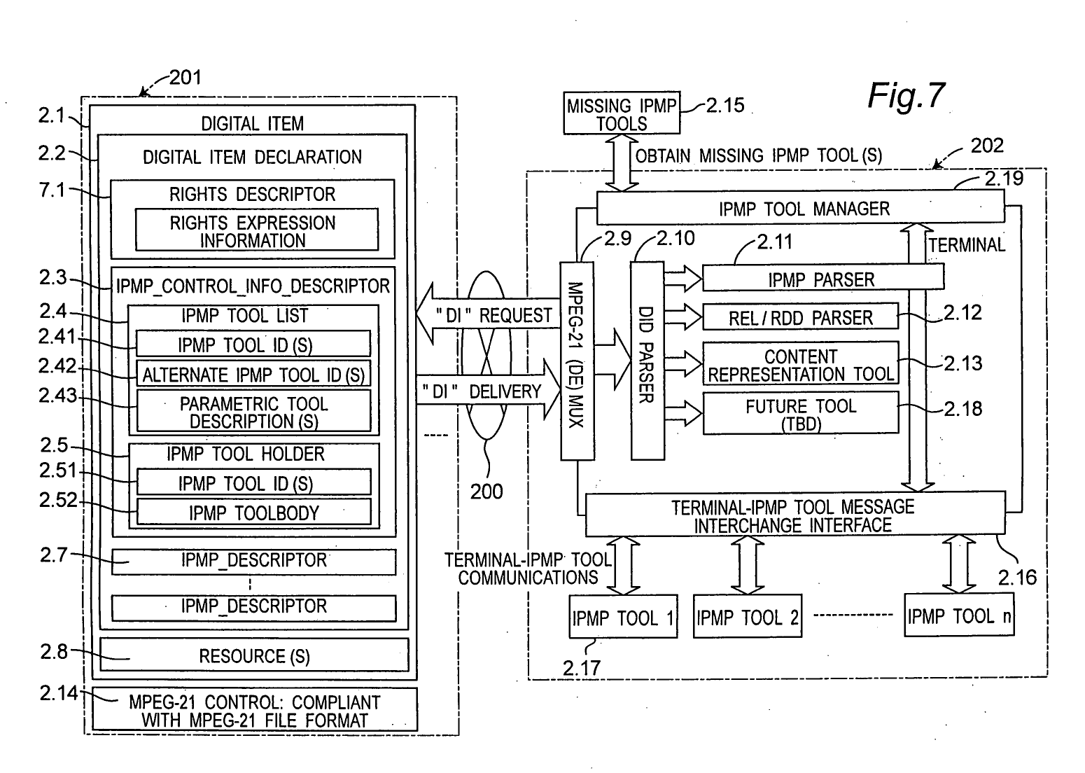

In the first embodiment, Rights Holder is placed under IPMP Control Information Descriptor in MPEG-21 IPMP System as shown in FIG. 2 since it is considered as one type of IPMP information. On the other hand, the REL is also possible to be placed in the same level of the IPMP Control information. This concept is illustrated in FIG. 7 as for the detail architecture of MPEG-21 IPMP system.

This diagram is an another updated version by incorporating other elements of MPEG-21 into MPEG-21 IPMP. In the left side a MPEG-21 Digital Item (module 2.1) protected by MPEG-21 IPMP is shown where Rights Descriptor or Rights holder (module 7.1) is holding REL information and is placed in DID Container 2.2 in the same level of IPMP Control information. In a MPEG-21 IPMP terminal 202, REL parser 2.12 and IPMP Parser 2.11 are required to interpret and transfer Rights permission and IPMP Control information to terminal 202 before starting to consume any content. In FIG. 7, same numerals are allocated to same elements as those in FIG. 2.

If Rights Expression part is protected by IPMP system, it is not convenient to retrieve IPMP information before IPMP Parser 2.11 is executed first. So in this case, IPMP Parser 2.11 has to be done by following REL Parser 2.12.

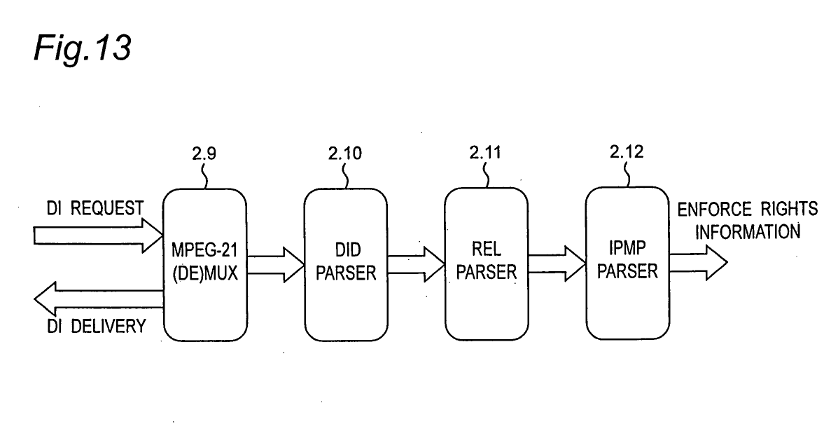

The FIG. 13 shows the flow chart of MPEG-21 DI consumption with Rights information carried outside and before IPMP Control Information. In FIG. 13, same numeral as that in FIGS. 2 and 7 is allocated to each element.

Then, mapping Rights Holder Position from MPEG-21 IPMP of MPEG-4 IPMP will be described.

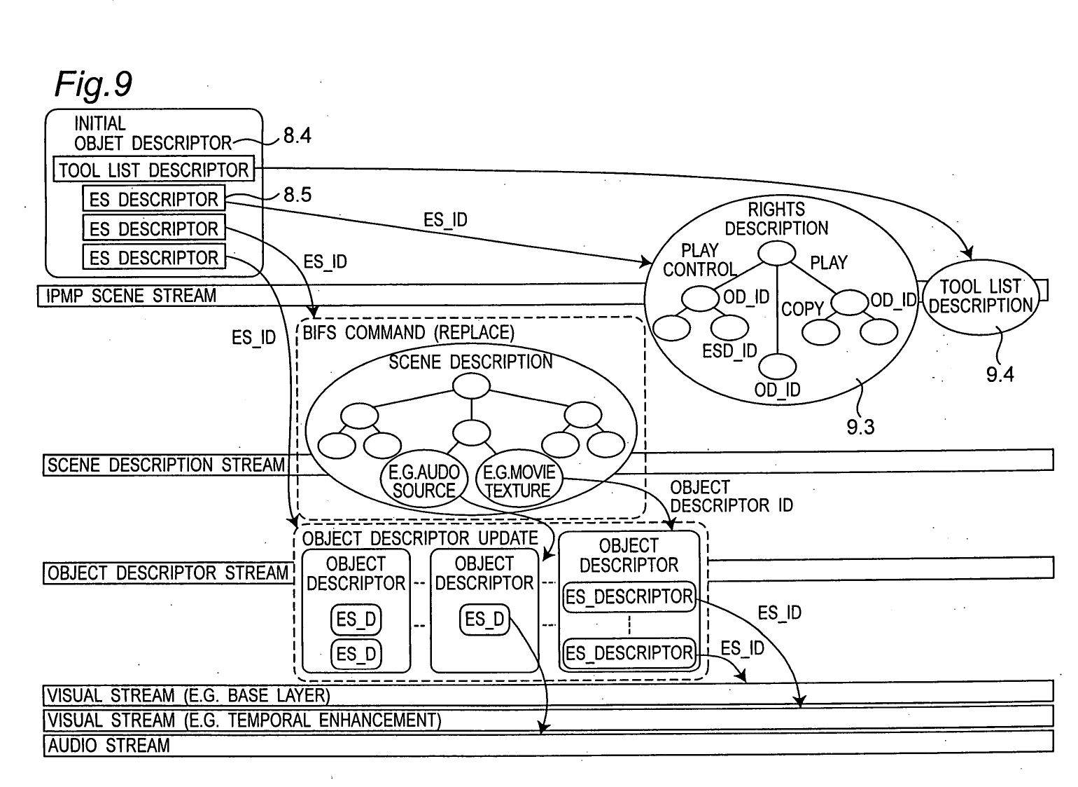

The reasonable place to carry such XML based Rights messages (in binary format) is in one of the Elementary Streams like Scene Description Stream or Object Description Stream, as shown in the Diagram, FIG. 9. Inside the IOD, an ES Descriptor (unit 9.1) will describe the stream and outside the IPMP Control Information in unit 9.2 but it parallels to IPMP Tool List Descriptor inside IPMP (refer to units 9.2 and 9.4).

Carrying the Rights Information in ES_Descriptor inside or outside the IPMP Control Information should have the same intent as described in the first embodiment of this invention.

Then, mapping Rights Holder Position from MPEG-21 IPMP to MPEG-2 IPMP will be described.

In MPEG-2 system, as indicated in current working draft of MPEG-2 IPMP, IPMP Control Information defined as another table besides PAT, PMT tables, is inserted to PSI (Program Specific Information) to describe IPMP related information as well as Rights information.

Before content is started to consume, all IPMP and Rights information will be retrieved and processed according to their associated PID (Program Identifier) numbers.

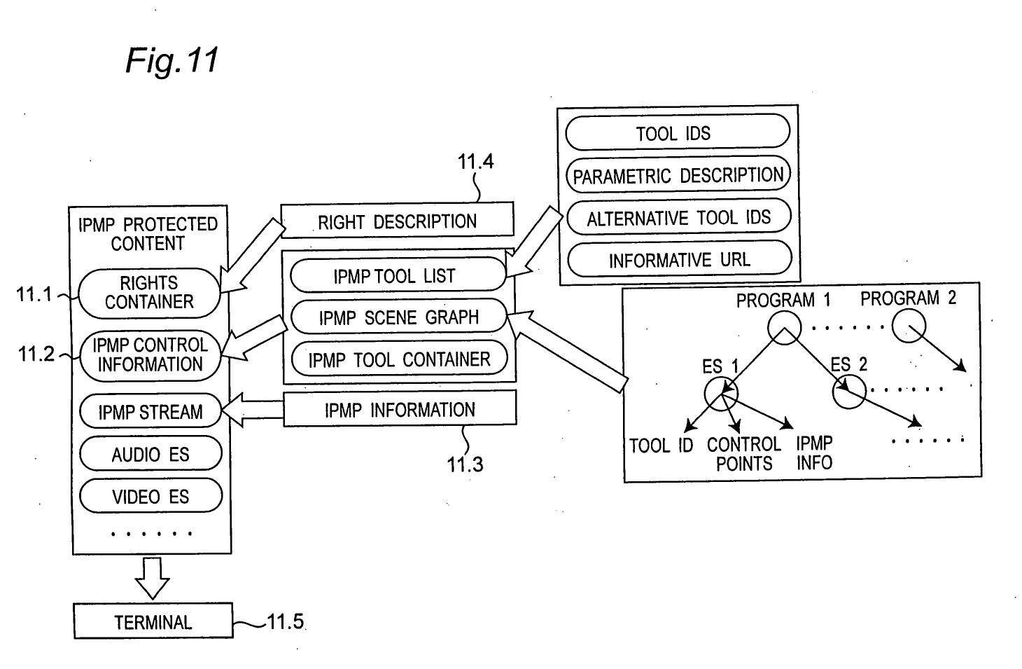

As shown in FIG. 11, a Content Structure protected by MPEG-2 IPMP system is illustrated where Rights information or Rights Description (unit 11.4) is carried in Rights Container (unit 11.1) parallel to IPMP Control Information (refer to units 11.2 and 11.3).

It is another good mapping from MPEG-21 IPMP to MPEG-2 IPMP since PSI is the entrance point in MPEG-2 IPMP just like DID is the entrance point in MPEG-21 IPMP.

IPMP and Rights information placed in PSI in MPEG-2 IPMP is similar to IPMP and Rights information placed in DID in MPEG-21 IPMP.

### Third Embodiment

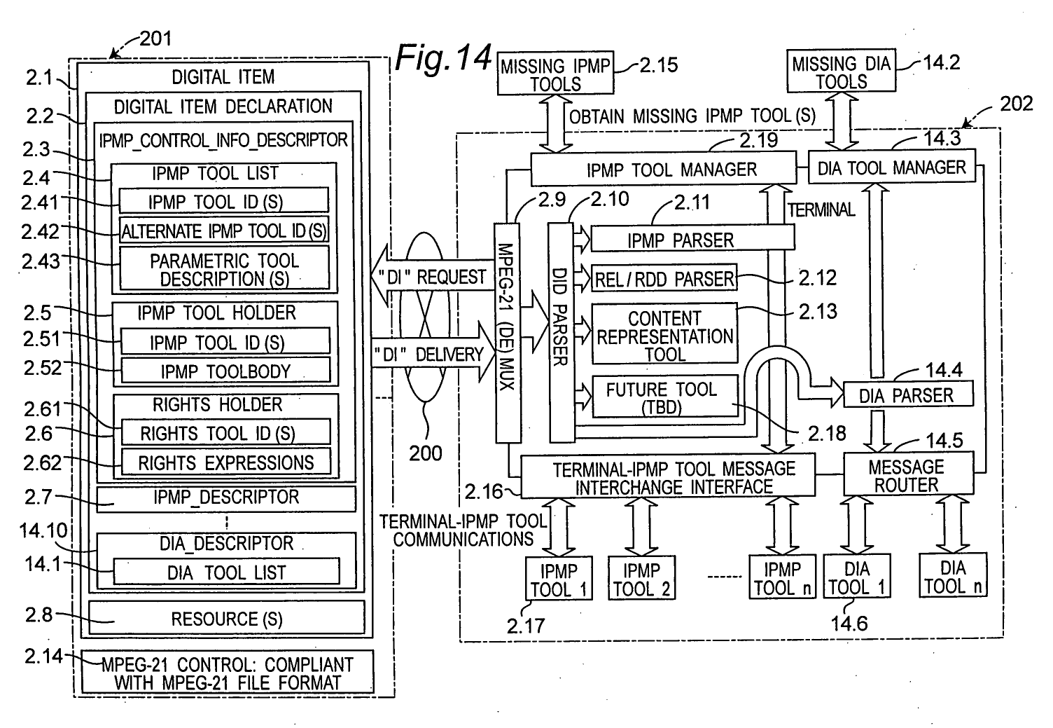

FIG. 14 shows a third embodiment of the invention. DID container 2.2 also includes a DIA Descriptor 14.10 including a DIA (Digital Item Adaptation) Tool List 14.1. Further, the Terminal 202 is also provided with a DIA Parser 14.4.

With regard to the DIA Descriptor 14.10, a process in the terminal 0.202 for consuming the digital item comprises the following steps of:

transferring the digital item to the DIA parser 14.4 if the digital item can not be directly consumed;

interpreting description of the DIA Descriptor 14.10 for the digital item;

interacting between the user and the terminal 202 to feed back information including user's terminal condition, network condition, and user's preference;

providing instructions for the user according to the feed backed information;

collecting DIA tools 14.6 by a DIA Tool Manager 14.3 for consuming the digital item; and

transferring the digital item to the DIA tools 14.6 for consumption.

Focusing on the DIA Tool List 14.1, the process comprising following steps of:

processing Information of DIA Tool List 14.1 by DIA Tool Manager 14.3;

retrieving missing DIA Tools 14.2 by defined or private manner;

collecting the DIA Tools 14.6 requested in the DIA Tool List 14.1;

installing the DIA Tools according to their functions in the terminal 202;

configuring and initiating the DIA Tools in the terminal 202 according to the DIA Tool Manager 14.3 and Description Messages (DIA Descriptor 14.10) received and processed by the DIA Parser 14.4; and

Activating the DIA Tools integrated in the terminal when there is needed.

In case that watermarking technique is used, the process further comprises the following steps of:

decrypting the protected digital item by the IPMP tool 2.17 indicated in the IPMP tool list 2.4 if the digital item is encrypted;

verifying IPMP related information, messages, and rights information if protected by digital signature;

authenticating tools, users, and terminals if they are indicated to be performed so;

extracting watermarks for copy control information/usage rules from the digital item for further processing if there is such indication in IPMP message parsed by the IPMP parser 2.11, DID description parsed by the DID parser 2.10, or DIA description parsed by the DIA parser 14.4;

extracting watermarks for authentication information from the said digital item for further processing if there is such indication in IPMP message parsed by the IPMP parser 2.11, DID description parsed by the DID parser 2.10, or DIA description parsed by the DIA parser 14.4;

extracting watermarks for persistent content ID information from the digital item for further processing if there is such indication in IPMP message parsed by the IPMP parser 2.11, DID description parsed by the DID parser 2.10, or DIA description parsed by the DIA parser 14.4;

consuming the said un-protected digital item by the representation tools;

embedding watermark information for updating copy control information/usage rules after consumption of the digital item.

### Fourth Embodiment

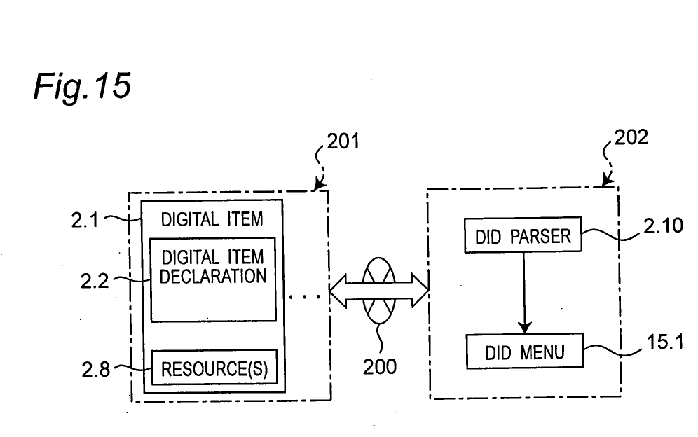

A DID menu for user's selection of specific digital item can be introduced to the MPEG-21 system of the invention. With making reference to FIG. 15, process in the terminal 202 for processing the DID menu comprises the following steps of:

receiving the DID menu from the server 201 together with other information in a carousel style via the network 200;

parsing the DID 2.2 by the DID Parser 2.10 in the terminal 202 to interpret the actual meaning of each element and statement by the terminal 202;

making the DID menu 15.1 to be readable by the user;

verifying rights and usage rules which is bound to the digital item 2.1 if there is REL information is found with the digital item;

receiving the requested digital item from the server 201;

un-protecting the digital item for further consumption if the digital item is protected by the IPMP;

identifying the resources 2.8 linked to the digital item;

collecting the requested tools including the IPMP tools (module 2.17) and DIA tools (module 14.6 in FIG. 14) for consumption of the digital item;

activating the tools based on the Message Interchange Interface (modules 2.16 and units 14.5 in FIG. 14).

### Fifth Embodiment

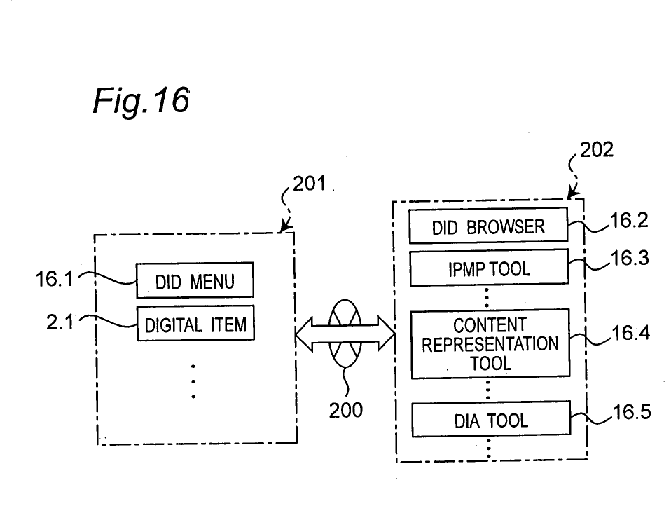

The DID menu can be stored in the sever 201 and browsed by a browser in the terminal. With making reference to FIG. 16, process in the terminal 202 for browsing and processing the DID menu comprises the following steps of:

browsing the DID menu 16.1 stored in the server 201 from a DID browser 16.2 in the terminal 202 remotely via the network 200;

parsing and interpreting each DID element by the DID browser 16.2;

selecting a digital item described by the DID (unit 2.2 in FIG. 14) by the user;

verifying rights and usage rules which is bound to the digital item if there is REL information is found with the digital item;

retrieving the requested digital item from the server 201;

un-protecting the digital item for further consumption if the digital item is protected by IPMP;

identifying the resources 2.8 linked to the digital item;

collecting the requested tools including the IPMP tools (module 2.17 in FIG. 14) and DIA tools (module 14.6 in FIG. 14) for consumption of the digital item;

activating the tools based on the Message Interchange Interface (modules 2.16 and units 14.5 in FIG. 14).

This invention solves the problem of designing an interoperable and secure architecture to be used in MPEG-21 DI delivery or transmission in a secure manner, by providing a standard way for MPEG-21 IPMP system implementers to build the whole IPMP system for MPEG-21 related “content” distribution and protection;

This invention solves the problem of designing an interoperable and secure architecture to be used in MPEG-21 DI delivery or transmission in a secure manner, by providing a standard way for MPEG-21 IPMP system implementers to build the whole IPMP system for MPEG-21 related “content” distribution and protection;

This invention also solves the problem of dynamically yet tightly associating rights information with MPEG-21 content, by designing appropriate places to put the Rights Holder including the important Rights Expression information under MPEG-21 architecture. The Rights Holder can either be put out of band, or put under IPMP system, or parallel to IPMP system, or scattered into resources.

This invention further solves similar rights association problem for MPEG-2/4 IPMP system by mapping the Rights Holder to MPEG-2/4 system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of digital item processing for use in an apparatus for a MPEG-21 system, comprising:
requesting a digital item to be delivered to the apparatus via a network,
receiving the requested digital item,
de-multiplexing the received digital item by a de-multiplexer,
retrieving a digital item container including a Digital Item Declaration (DID) including one or more elements from the de-multiplexed digital item,
parsing the DID by a DID parser to interpret the actual meanings of each element of the DID, and
transferring the element to an Intellectual Property Management and Protection (IPMP) parser for activating an IPMP tool if the interpreted element is related to protection and management of the digital item.

2. A method according to claim 1, further comprising:
transferring the element to a Rights Expression Language/Rights Dictionary Declaration (REL/RDD) parser if the interpreted element is related to rights information including rights and usage rules for the digital item.

3. A method according to claim 2, further comprising:
transferring the element to a content representation tool if the interpreted element is related to content representation and consumption, and
activating the content representation tool.

4. A method according to claim 3, further comprising:
transferring the element to a future defined tools if the interpreted element is related to functions other than IPMP and REL/RDD.

5. A method according to claim 1, further comprising:
processing an IPMP tool list included in the DID by a IPMP tool manager,
retrieving a missing IPMP tool,
collecting all the IPMP tools requested in the IPMP tool list,
installing the IPMP tool according to its function,
configuring and initiating the IPMP tool according to an IPMP messages received and processed by the IPMP parser, and
activating the IPMP tool.

6. A method according to claim 1, wherein a tool identifier (ID) is assigned to each IPMP tool,
wherein an IPMP tool list is created to indicate which IPMP tool is used for protecting the digital item, and
wherein the IPMP tool list is carried in an IPMP control information descriptor included in the DID container,
the method further comprising:
retrieving IPMP control information from the IPMP control information descriptor when the DID is parsed by the DID parser,
transferring the IPMP control information to the IPMP parser,
transferring the IPMP tool list to an IPMP tool manager,
processing the IPMP tool list by the IPMP tool manager, and
retrieving the IPMP tool if there is a missing IPMP tool.

7. A method according to claim 1, wherein an IPMP control information descriptor is included in the DID container, further comprising:
retrieving the IPMP control information descriptor including an IPMP tool list, an IPMP tool holder, and a right holder from the DID container when the DID is parsed by the DID parser,
transferring the IPMP control information descriptor to the IPMP parser,
retrieving the IPMP tool list from the IPMP control information descriptor by the IPMP parser,
retrieving the IPMP tool if it is carried in the IPMP toll holder, and
retrieving rights information if such information is carried in the right holder.

8. A method according to claim 2, wherein the DID container includes an IPMP control information descriptor including a right holder with a right tool ID and a right expression, and
wherein rights information including rights and usage rules is carried in the right holder, and
wherein different rights and usage rules are associated with the corresponding digital items using their persistent IDs in the rights information,
the method further comprising:
parsing the IPMP control information descriptor to retrieve the right holder by the IPMP parser,
transferring the right holder to the REL/RDD parser,
parsing the right holder by the REL/RDD parser to interpret the rights and usage rules, and
verifying the rights and usage rules associated with the digital item.

9. A method according to claim 2, wherein the DID container includes an IPMP control information descriptor and a right holder with a right tool ID and a right expression, the DID container and the right holder being parallel within the DID container,
wherein all rights information including rights and usage rules is carried in the right holder, and
wherein the different rights and usage rules are associated with the corresponding digital items using their persistent IDs in the rights information,
the method further comprising:
retrieving the right holder in the DID parsed by the DID parser,
transferring the right holder to the REL/RDD parser,
parsing the right holder by the REL/RDD parser to interpret the rights and usage rules,
verifying the rights and usage rules associated with the digital item.

10. A method according to claim 2, wherein right information including rights and usage rules is carried out of band,
wherein a header for REL/RDD information is defined to indicate the right information
wherein the different rights and usage rules are associated with the corresponding digital items using their persistent IDs in the rights information,
receiving the header with other information,
stripping the header to retrieve the REL/RDD information,
transferring the REL/RDD information to the REL/RDD parser to interpret the rights and usage rules, and
verifying the rights and usage rules associated with the digital item.

11. A method according to claim 8, wherein the rights information including the rights and usage rules is contained in the IPMP control information descriptor,
wherein the IPMP control information is carried in initial object descriptor (IOD) for MPEG-4 system, and
wherein the apparatus is compliant with MPEG-4 standard,
the method further comprising:
receiving the IOD with other information,
retrieving the IOD to obtain the IPMP control information descriptor, and
parsing and interpreting the right information by the REL/RDD parser.

12. A method according to claim 9, wherein the IPMP control information descriptor and right information including rights and usage rules are respectively carried in different IODs for MPEG-4 system in parallel,
wherein the apparatus is compliant with MPEG-4 standard,
the method further comprising:
receiving the IOD with other information,
retrieving the IOD to obtain the IPMP control information descriptor, and
parsing and interpreting the right information by the REL/RDD parser.

13. A method according to claim 8, wherein the rights information including the rights and usage rules is contained in the IPMP control information descriptor,
wherein the IPMP control information descriptor and rights information are carried in program specific information (PSI) for MPEG-2 system, and
wherein the apparatus is compliant with MPEG-2 standard,
the method further comprising:
receiving the PSI with other information,
retrieving the PSI to obtain the IPMP Control Information descriptor,
retrieving the rights information, and
parsing and interpreting the rights information by the REL/RDD parser.

14. A method according to claim 9, wherein the rights information including rights and usage rules is carried in a rights container included in PSI for MPEG-2 system, the right container being in parallel to the IPMP control information descriptor in the PSI, and
wherein the apparatus is compliant with MPEG-2 standard,
the method further comprising,
receiving the PSI with other information,
retrieving the PSI to obtain the rights information by the REL/RDD parser, and
parsing and interpreting the right information by the REL/RDD parser.

15. A method according to claim 2, wherein the rights information is carried in a right holder,
wherein the right holder is associated with the corresponding digital items, and
wherein the right holder is in the front of the whole digital item container.

16. A method according to claim 2, wherein the rights information is carried in a rights holder, and
wherein the right holder is scattered locally with each of the relevant digital items, and delivered to the apparatus directly associated with its relevant digital item.

17. A method according to claim 1, further comprising:
transferring the digital item to a digital item adaptation (DIA) parser if the digital item is to be consumed indirectly,
interpreting description of the DIA for the digital item,
interacting between the user and the apparatus to feed back information including user's terminal condition, network condition, and user's preference,
providing instructions for the user according to the feed backed information,
collecting a DIA tool for consuming the digital item, and
transferring the digital item to the DIA tool for consumption.

18. A method according to claim 1, wherein the digital item container further includes a DIA tool list,
the method further comprising:
processing the DIA tool list by the DIA tool manager,
collecting the DIA tools requested in the DIA tool list,
installing the collected DIA tools according to their functions,
configuring and initiating the DIA tools according to predetermined message interface and description message received and processed by a DIA parser, and
activating the DIA tool.

19. A method according to claim 17, wherein the digital item is un-protected for further consumption if the digital item is protected by IPMP,
the method further comprising:
decrypting the protected digital item by the IPMP tool indicated in the IPMP tool list if the digital item is encrypted,
verifying IPMP related information, messages, and rights information if protected by digital signature,
authenticating tools, users, and terminals if they are indicated to be performed so,
extracting watermarks for copy control information/usage rules from the digital item for further processing if there is such indication in IPMP message parsed by the IPMP parser, DID description parsed by the DID parser, or DIA description parsed by the DIA parser,
extracting watermarks for authentication information from the digital item for further processing if there is such indication in IPMP message parsed by the IPMP parser, DID description parsed by the DID parser, or DIA description parsed by the DIA parser,
extracting watermarks for persistent content ID information from the digital item for further processing if there is such indication in IPMP message parsed by the IPMP parser, DID description parsed by the DID parser, or DIA description parsed by the DIA parser,
consuming the un-protected digital item by the representation tools,
embedding watermark information for updating copy control information/usage rules after consumption of the digital item.

20. A method of digital item processing in an apparatus for a MPEG-21 system, comprising:
receiving a DID menu together with other information including DID in a carousel style via a network,
parsing DID by a DID parser to interpret the actual meaning of each element of the DID,
making the DID menu to be readable by a user,
selecting a digital item from the DID menu by the user,
verifying rights and usage rules which is bound to the digital item if REL information is found with the digital item,
retrieving the requested digital item,
un-protecting the digital item for further consumption if the digital item is protected by IPMP,
identifying a resource linked to the digital item,
collecting the requested tools including IPMP tools, content representation tools, and DIA tools for consumption of the digital item,
activating the tools according to predetermined message interface if such tools are required in the consumption of the digital item.

21. A method of digital item processing in a MPEG-21 system, wherein the system includes a server and a client, comprising:
browsing a DID menu stored in the server remotely from the client by a DID browser via a network,
parsing and interpreting each DID element by the DID browser,
selecting a digital item described by the DID by a user,
verifying rights and usage rules bound to the digital item if REL information is found with the digital item,
retrieving the requested digital item from the server to the client,
un-protecting the digital item for further consumption if the digital item is protected by IPMP,
identifying a resource linked to the digital item,
collecting the requested tools including IPMP tools, content representation tools, and DIA tools for consumption of the digital item,
activating the tools according to predetermined message interface if such tools are required in the consumption of the digital item.
